(19) United States
(12) Patent Application Publication
(10) Pub. No.: US 2022/0233039 A1
(43) Pub. Date: Jul. 28, 2022

(54) ROLLERS FOR VACUUM CLEANERS

(71) Applicant: LUPE TECHNOLOGY LIMITED, Bristol (GB)

(72) Inventors: Lucas HORNE, Bristol (GB); Pablo MONTERO-COWELL, Bristol (GB); Oliver SKITTERY, Bristol (GB)

(73) Assignee: LUPE TECHNOLOGY LIMITED, Bristol (GB)

(21) Appl. No.: 17/614,874

(22) PCT Filed: May 13, 2020
(86) PCT No.: PCT/EP2020/063345

§ 371 Date: Nov. 29, 2021

(30) Foreign Application Priority Data
May 30, 2019 (GB) 1907652.0

(51) Int. Cl. A47L 9/04; B29C 69/02

(52) U.S. Cl. CPC A47L 9/0477; B29K 2105/04; B29C 69/02

(57) ABSTRACT

A roller for a vacuum cleaner comprises: an interior roller body which comprises a resiliently deformable region; and an exterior abrasion-resistant skin which surrounds the interior roller body.

### FIELD

The present disclosure concerns rollers for vacuum cleaners, vacuum cleaner heads and vacuum cleaners comprising rollers, kits of parts comprising rollers for vacuum cleaners, and methods of manufacturing rollers for vacuum cleaners.

### BACKGROUND

Vacuum cleaners are a well-known form of appliance. Most vacuum cleaners today operate in a fundamentally similar way. The vacuum cleaner comprises a cleaner head (pick-up head) which is pushed across a surface, a separation system which can separate dirt/dust from an airflow, and a suction source (typically a motor and an impeller) to generate an airflow through the cleaner head and separation system. Dust/dirt is drawn from the surface to be cleaned and entrained in an airflow. The dirty airflow is pulled from the cleaner head to the separation system. Cleaned air is exhausted to the room. As the air is exhausted, a negative pressure is created at the pickup head.

There are many variations of separation systems: (filter bags, cyclonic separators, water tank) and sizes and designs of motor.

Different types of floor surface present different challenges. For carpeted floors, it is known to use a cleaner head with an agitator, such as a beater bar or a brush bar with stiff bristles for beating the carpet. The beater bar can be driven by an electric motor at high speeds, commonly between 2,000 and 8,000 RPM, to beat the carpet. The beater bar employs radially protruding stiff bristles, such as those disclosed in U.S. Pat. No. 1,886,129, to part the carpet pile as the agitator is rotated. This high-speed rotation greatly improves the amount of dust that can be freed from within the carpet pile, to be entrained in an airflow and then collected in the vacuum bag or collection chamber. This has the advantage that the stiff bristles agitate the carpet to release debris from within the pile and a higher dust pick up efficiency can be attained on carpet compared to a cleaner head without an agitator.

On hard floor surfaces, an agitator is generally not used as the high-speed rotation of the agitator and contact with the floor surface can mark and damage hard floors. In some types of cleaner, such as an upright machine provided with an agitator, the agitator can be turned off when the cleaner is used to clean hard floors. On other cleaners, a cleaner head without an agitator may be provided. This is known as a passive head in the art.

A passive cleaner head may be provided with linear brush seals. An example of a passive head with seals is described in GB 2,374,523 A. This improves sealing between the cleaner head and the floor surface. A disadvantage of this type of cleaner head is that the brush seals prevent large debris from entering the cleaner head. Debris is pushed along in front of the cleaner head. Cleaner heads of this type have to be lifted off the surface to pick up large debris, losing the effect of the suction when trying to draw dust out from crevices and cracks underneath the head.

### SUMMARY OF INVENTION

According to a first aspect, there is provided a roller for a vacuum cleaner, the roller comprising: an interior roller body which comprises a resiliently deformable region; and an exterior abrasion-resistant skin which surrounds the interior roller body.

The roller may be a roller for a cleaner head of a vacuum cleaner. The roller may be a roller for a cleaner head of the type which comprises an agitator, such as a beater bar, and a rotatable sealing element. The roller may function as (i.e. be) the rotatable sealing element. Because the interior roller body comprises a resiliently deformable region, the interior roller body (and therefore at least a portion of the roller) is able to be deformed, for example when the roller rolls over debris on a surface. Accordingly, the roller is able to roll over debris without exerting excessive forces on the debris such that the debris is not damaged (e.g. crushed) by the roller. Moreover, the debris is not pushed ahead of the roller, such that the debris may be picked up by the vacuum cleaner without having to lift the cleaner head away from the surface on which the debris is located. In addition, because the interior roller body is resiliently deformable, the exterior abrasion-resistant skin can be maintained in contact with the surface as the roller rolls over the debris such that there is no, or minimal, loss of suction. Because the exterior abrasion-resistant skin is abrasion resistant, it is also unlikely to be damaged as the roller rolls over debris.

It may be that the resiliently deformable region of the interior roller body is a resiliently compressible region.

It may be that the exterior abrasion-resistant skin exhibits an abrasion loss, during abrasion resistance testing according to DIN 53516, of no greater than about 150 mm³, for example, no greater than about 140 mm³, or no greater than about 130 mm³, or no greater than about 120 mm³, or no greater than about 110 mm³, or no greater than about 100 mm³, or no greater than about 90 mm³, or no greater than about 80 mm³, or no greater than about 70 mm³, or no greater than about 60 mm³, or no greater than about 50 mm³, or no greater than about 40 mm³, or no greater than about 30 mm³. It may be that the exterior abrasion-resistant skin exhibits an abrasion loss, during abrasion resistance testing according to DIN 53516, of no less than about 1 mm³, for example, no less than about 5 mm³, or no less than about 10 mm³, or no less than about 15 mm³, or no less than about 20 mm³, or no less than about 25 mm³, or no less than about 30 mm³. It may be that the exterior abrasion-resistant skin exhibits an abrasion loss, during abrasion resistance testing according to DIN 53516, of from about 1 mm³ to about 150 mm³, for example, from about 1 mm³ to about 140 mm³, or from about 1 mm³ to about 130 mm³, or from about 1 mm³ to about 120 mm³, or from about 1 mm³ to about 110 mm³, or from about 1 mm³ to about 100 mm³, or from about 1 mm³ to about 90 mm³, or from about 1 mm³ to about 80 mm³, or from about 1 mm³ to about 70 mm³, or from about 1 mm³ to about 60 mm³, or from about 1 mm³ to about 50 mm³, or from about 1 mm³ to about 40 mm³, or from about 1 mm³ to about 30 mm³, or from about 5 mm³ to about 150 mm³, or from about 5 mm³ to about 140 mm³, or from about 5 mm³ to about 130 mm³, or from about 5 mm³ to about 120 mm³, or from about 5 mm³ to about 110 mm³, or from about 5 mm³ to about 100 mm³, or from about 5 mm³ to about 90 mm³, or from about 5 mm³ to about 80 mm³, or from about 5 mm³ to about 70 mm³, or from about 5 mm³ to about 60 mm³, or from about 5 mm³ to about 50 mm³, or from about 5 mm³ to about 40 mm³, or from about 5 mm³ to about 30 mm³, or from about 10 mm³ to about 150 mm³, or from about 10 mm³ to about 140 mm³, or from about 10 mm³ to about 130 mm³, or from about 10 mm³ to about 120 mm³, or from about 10 mm³ to about 110 mm³, or from about 10 mm³ to about 100 mm³, or from about 10 mm³ to about 90 mm³, or from about 10 mm³ to about 80 mm³, or from about 10 mm³ to about 70 mm³, or from about 10 mm³ to about 60 mm³, or from about 10 mm³ to about 50 mm³, or from about 10 mm³ to about 40 mm³, or from about 10 mm³ to about 30 mm³, or from about 15 mm³ to about 150 mm³, or from about 15 mm³ to about 140 mm³, or from about 15 mm³ to about 130 mm³, or from about 15 mm³ to about 120 mm³, or from about 15 mm³ to about 110 mm³, or from about 15 mm³ to about 100 mm³, or from about 15 mm³ to about 90 mm³, or from about 15 mm³ to about 80 mm³, or from about 15 mm³ to about 70 mm³, or from about 15 mm³ to about 60 mm³, or from about 15 mm³ to about 50 mm³, or from about 15 mm³ to about 40 mm³, or from about 15 mm³ to about 30 mm³, or from about 20 mm³ to about 150 mm³, or from about 20 mm³ to about 140 mm³, or from about 20 mm³ to about 130 mm³, or from about 20 mm³ to about 120 mm³, or from about 20 mm³ to about 110 mm³, or from about 20 mm³ to about 100 mm³, or from about 20 mm³ to about 90 mm³, or from about 20 mm³ to about 80 mm³, or from about 20 mm³ to about 70 mm³, or from about 20 mm³ to about 60 mm³, or from about 20 mm³ to about 50 mm³, or from about 20 mm³ to about 40 mm³, or from about 20 mm³ to about 30 mm³, or from about 25 mm³ to about 150 mm³, or from about 25 mm³ to about 140 mm³, or from about 25 mm³ to about 130 mm³, or from about 25 mm³ to about 120 mm³, or from about 25 mm³ to about 110 mm³, or from about 25 mm³ to about 100 mm³, or from about 25 mm³ to about 90 mm³, or from about 25 mm³ to about 80 mm³, or from about 25 mm³ to about 70 mm³, or from about 25 mm³ to about 60 mm³, or from about 25 mm³ to about 50 mm³, or from about 25 mm³ to about 40 mm³, or from about 25 mm³ to about 30 mm³, or from about 30 mm³ to about 150 mm³, or from about 30 mm³ to about 140 mm³, or from about 30 mm³ to about 130 mm³, or from about 30 mm³ to about 120 mm³, or from about 30 mm³ to about 110 mm³, or from about 30 mm³ to about 100 mm³, or from about 30 mm³ to about 90 mm³, or from about 30 mm³ to about 80 mm³, or from about 30 mm³ to about 70 mm³, or from about 30 mm³ to about 60 mm³, or from about 30 mm³ to about 50 mm³, or from about 30 mm³ to about 40 mm³.

It may be that the exterior abrasion-resistant skin has, or comprises (e.g. is formed from) a material having, a Shore A hardness (as measured by durometer according to ASTM D2240) of no less than about 40, for example, no less than about 50, or no less than about 60, or no less than about 70, or no less than about 80. It may be that the exterior abrasion-resistant skin has, or comprises (e.g. is formed from) a material having, a Shore A hardness (as measured by durometer according to ASTM D2240) of no greater than about 100, for example, no greater than about 95, or no greater than about 90. It may be that the exterior abrasion-resistant skin has, or comprises (e.g. is formed from) a material having, a Shore A hardness (as measured by durometer according to ASTM D2240) from about 40 to about 100, for example, from about 50 to about 100, or from about 60 to about 100, or from about 70 to about 100, or from about 80 to about 100, or from about 40 to about 95, or from about 50 to about 95, or from about 60 to about 95, or from about 70 to about 95, or from about 80 to about 95, or from about 40 to about 90, or from about 50 to about 90, or from about 60 to about 90, or from about 70 to about 90, or from about 80 to about 90.

It may be that the exterior abrasion-resistant skin has, or comprises (e.g. is formed from) a material having, a tensile strength (i.e. a tensile skin strength) of no less than about 10 N/mm², for example, no less than about 20 N/mm², or no less than about 30 N/mm², or no less than about 40 N/mm², or no less than about 45 N/mm². It may be that the exterior abrasion-resistant skin has, or comprises (e.g. is formed from) a material having, a tensile strength (i.e. a tensile skin strength) of no greater than about 100 N/mm², for example, no greater than about 90 N/mm², or no greater than about 80 N/mm², or no greater than about 70 N/mm², or no greater than about 60 N/mm², or no greater than about 50 N/mm². It may be that the exterior abrasion-resistant skin has, or comprises (e.g. is formed from) a material having, a tensile strength (i.e. a tensile skin strength) from about 10 N/mm² to about 100 N/mm², for example, from about 10 N/mm² to about 90 N/mm², or from about 10 N/mm² to about 80 N/mm², or from about 20 N/mm² to about 70 N/mm², or from about 30 N/mm² to about 60 N/mm², or from about 40 N/mm² to about 50 N/mm², or from about 45 N/mm² to about 50 N/mm², for example about 47 N/mm².

It may be that the exterior abrasion-resistant skin has, or comprises (e.g. is formed from) a material having, an elongation to failure of no less than about 100%, for example, no less than about 200%, or no less than about 300%, or no less than about 400%, or no less than about 500%. It may be that the exterior abrasion-resistant skin has, or comprises (e.g. is formed from) a material having, an elongation to failure of no greater than about 1500%, for example, no greater than about 1000%, or no greater than about 900%. It may be that the exterior abrasion-resistant skin has, or comprises (e.g. is formed from) a material having, an elongation to failure from about 100% to about 1500%, for example, from about 200% to about 1500%, or from about 300% to about 1500%, or from about 400% to about 1500%, or from about 500% to about 1500%, or from about 100% to about 1000%, or from about 200% to about 1000%, or from about 300% to about 1000%, or from about 400% to about 1000%, or from about 500% to about 1000%, or from about 100% to about 900%, or from about 200% to about 900%, or from about 300% to about 900%, or from about 400% to about 900%, or from about 500% to about 900%.

It may be that the exterior abrasion-resistant skin has, or comprises (e.g. is formed from) a material having, a tear resistance (according to ASTM D412) of no less than about 30 kN/m, for example, no less than about 40 kN/m, or no less than about 50 kN/m, or no less than about 60 kN/m, or no less than about 70 kN/m, or no less than about 80 kN/m, or no less than about 90 kN/m, or no less than about 100 kN/m. It may be that the exterior abrasion-resistant skin has, or comprises (e.g. is formed from) a material having, a tear resistance (according to ASTM D412) of no greater than about 200 kN/m, for example, no greater than about 150 kN/m. It may be that the exterior abrasion-resistant skin has, or comprises (e.g. is formed from) a material having, a tear resistance (according to ASTM D412) from about 30 kN/m to about 200 kN/m, for example, from about 40 kN/m to about 200 kN/m, or from about 50 kN/m to about 200 kN/m, or from about 60 kN/m to about 200 kN/m, or from about 70 kN/m to about 200 kN/m, or from about 80 kN/m to about 200 kN/m, or from about 90 kN/m to about 200 kN/m, or from about 100 kN/m to about 200 kN/m, or from about 30 kN/m to about 150 kN/m, or from about 40 kN/m to about 150 kN/m, or from about 50 kN/m to about 150 kN/m, or from about 60 kN/m to about 150 kN/m, or from about 70 kN/m to about 150 kN/m, or from about 80 kN/m to about 150 kN/m, or from about 90 kN/m to about 150 kN/m, or from about 100 kN/m to about 150 kN/m.

It may be that the exterior abrasion-resistant skin comprises (e.g. is formed from) a polymeric material (e.g. an abrasion-resistant polymeric material). The (e.g. abrasion-resistant) polymeric material may be an (e.g. abrasion-resistant) elastomeric material.

It may be that the exterior abrasion-resistant skin comprises (e.g. is formed from) a polyurethane. It may be that the exterior abrasion-resistant skin comprises (e.g. is formed from) a thermoplastic polyurethane (TPU). It may be that the exterior abrasion-resistant skin comprises (e.g. is formed from) a polyether-based thermoplastic polyurethane. Alternatively, it may be that the exterior abrasion-resistant skin comprises (e.g. is formed from) polyvinyl chloride, for example flexible polyvinyl chloride.

It may be that the exterior abrasion-resistant skin comprises (e.g. is formed from) a rubber such as polyisoprene, natural rubber and/or synthetic rubber (e.g. styrene-butadiene rubber).

It may be that the exterior abrasion-resistant skin comprises (e.g. is formed from) a fabric, e.g. an abrasion-resistant fabric. The (e.g. abrasion-resistant) fabric may be woven or non-woven. The (e.g. abrasion-resistant) fabric may be made of a polymeric material.

For example, the (e.g. abrasion-resistant) fabric may be made of a nylon, such as nylon 66, nylon 6, nylon 510, or nylon 1,6. The (e.g. abrasion-resistant) fabric may be made of a polyester. The (e.g. abrasion-resistant) fabric may be made of a polyethylene, for example ultra-high-molecular-weight polyethylene (UHMWPE). The (e.g. abrasion-resistant) fabric may be made of an aramid (i.e. an aromatic polyamide), for example a para-aramid (such as Kevlar® or Twaron®) or a meta-aramid (such as Nomex®).

It may be that the exterior abrasion-resistant skin is textured. For example, the exterior abrasion-resistant skin may comprise (e.g. be formed from) artificial leather, e.g. polyurethane leather.

It may be that the material (e.g. the polymeric material), which the exterior abrasion-resistant skin comprises (e.g. from which the exterior abrasion-resistant skin is formed), has a Young's modulus of no greater than about 2 GPa, for example, no greater than about 1.5 GPa, or no greater than about 1 GPa. It may be that the material (e.g. the polymeric material), which the exterior abrasion-resistant skin comprises (e.g. from which the exterior abrasion-resistant skin is formed), has a Young's modulus of no less than about 0.01 GPa, for example, no less than about 0.1 GPa. It may be that the material (e.g. the polymeric material), which the exterior abrasion-resistant skin comprises (e.g. from which the exterior abrasion-resistant skin is formed), has a Young's modulus from about 0.01 GPa to about 2 GPa, for example, from about 0.01 GPa to about 1.5 GPa, or from about 0.01 GPa to about 1 GPa, or from about 0.1 GPa to about 2 GPa, or from about 0.1 GPa to about 1.5 GPa, or from about 0.1 GPa to about 1 GPa.

It may be that the exterior abrasion-resistant skin is adhered to the interior roller body. It may be that the exterior abrasion-resistant skin is adhered (i.e. directly) to the resiliently deformable (e.g. compressible) region of the interior roller body. It may be that the exterior abrasion-resistant skin is adhered by way of adhesive to the interior roller body (e.g. (i.e. directly) to the resiliently deformable (e.g. compressible) region of the interior roller body).

It may be that the exterior abrasion-resistant skin is integrally formed with the interior roller body (e.g. with the resiliently deformable (e.g. compressible) region of the interior roller body).

It may be that the exterior abrasion-resistant skin is not adhered to the interior roller body. It may be that the exterior abrasion-resistant skin is not adhered to the resiliently deformable (e.g. compressible) region of the interior roller body. It may be, however, that the exterior abrasion-resistant skin and the interior roller body (e.g. the resiliently deformable (e.g. compressible) region of the interior roller body) are held in contact, for example by an interference fit between the exterior abrasion-resistant skin and the interior roller body.

It may be that the exterior abrasion-resistant skin has a thickness of no less than about 50 μm, for example, no less than about 100 μm, or no less than about 150 μm, or no less than about 200 μm. It may be that the exterior abrasion-resistant skin has a thickness of no greater than about 1000 μm, for example, no greater than about 750 μm, or no greater than about 500 μm, or no greater than about 400 μm, or no greater than about 300 μm. It may be that the exterior abrasion-resistant skin has a thickness of from about 50 μm to about 1000 μm, for example, from about 50 μm to about 750 μm, or from about 50 μm to about 500 μm, or from about 100 μm to about 400 μm, or from about 150 μm to about 300 μm, or from about 200 μm to about 300 μm.

It may be that the thickness of the exterior abrasion-resistant skin is substantially uniform. For example, it may be that the thickness of the exterior abrasion-resistant skin is substantially uniform along no less than about 50%, for example, no less than about 75%, or no less than about 95%, for example along about 100%, of a longitudinal length of the roller. Additionally or alternatively, it may be that the thickness of the exterior abrasion-resistant skin is substantially uniform around no less than about 50%, for example, no less than about 75%, or no less than about 95%, for example around about 100%, of a perimeter (e.g. circumference) of the roller in cross-section perpendicular to the longitudinal axis of the roller, for example measured at the midpoint of the roller along the longitudinal axis. It will be appreciated that in this regard the term “substantially uniform” encompasses minor variations in the thickness of the exterior abrasion-resistant skin, for example variations in the thickness of no greater than about 15% along the longitudinal length and/or around the perimeter of the roller.

It may be that the thickness of the exterior abrasion-resistant skin is no greater than about 10%, for example, no greater than about 5%, of a diameter of the roller perpendicular to the longitudinal axis of the roller.

It will be appreciated that the thickness of the exterior abrasion-resistant skin is measured along an axis perpendicular to the external surface of the exterior abrasion-resistant skin, i.e. perpendicular to the longitudinal axis of the roller.

It may be that the exterior abrasion-resistant skin is formed (e.g. predominantly, for example entirely) from a non-porous material (such as thermoplastic polyurethane). Accordingly, it may be that the exterior abrasion-resistant skin comprises (e.g. consists of) the non-porous material (such as thermoplastic polyurethane). Use of a non-porous material to form the exterior abrasion-resistant skin may facilitate maintenance of sealing contact between the exterior abrasion-resistant skin and the surface as the roller rolls over debris, i.e. such that there is no, or minimal, loss of suction.

It may be that the exterior abrasion-resistant skin is non-porous. It may be that the exterior abrasion-resistant skin is gas-impermeable, e.g. air-impermeable. It may be that the exterior abrasion-resistant skin is formed of a continuous, solid material (i.e. a non-cellular, void-less material). Use of a non-porous, gas-impermeable and/or continuous, solid exterior abrasion-resistant skin may facilitate maintenance of sealing contact between the exterior abrasion-resistant skin and the surface as the roller rolls over debris, i.e. such that there is no, or minimal, loss of suction.

It will be appreciated that the resiliently deformable (e.g. compressible) region of the interior roller body is a region of the interior roller body which can be deformed (e.g. compressed) from a first (e.g. undeformed, for example uncompressed) state (e.g. shape) to a second (e.g. deformed, for example compressed) state (e.g. shape) by the application of a force, and which returns to the first (e.g. undeformed, for example uncompressed) state (e.g. shape) when the force is released. That is to say, the resiliently deformable (e.g. compressible) region of the interior roller body is typically able to undergo elastic or viscoelastic deformation (e.g. compression).

It may be that the resiliently deformable (e.g. compressible) region is porous. It may be that the resiliently deformable (e.g. compressible) region is cellular, i.e. formed of a cellular material. It may be that the resiliently deformable (e.g. compressible) region is a foam, that is to say it may be that the resiliently deformable (e.g. compressible) region has a foam structure. The foam may be a closed-cell foam. The foam may be an open-cell foam.

Alternatively, it may be that the resiliently deformable (e.g. compressible) region is non-porous. It may be that the resiliently deformable (e.g. compressible) region is non-cellular. It may be that the resiliently deformable (e.g. compressible) region is formed of a continuous (i.e. a non-cellular, void-less) material. It may be that the resiliently deformable (e.g. compressible) region is formed of a continuous, solid material.

It may be that the structure of the resiliently deformable (e.g. compressible) region is substantially uniform when in an undeformed (e.g. uncompressed) state (i.e. when not subject to externally applied forces tending to cause deformation or compression of the resiliently deformable (e.g. compressible) region). For example, it may be that the density, porosity, pore density and/or pore size of the resiliently deformable (e.g. compressible) region is substantially uniform in the undeformed (e.g. uncompressed) state. It may be that the structure (e.g. density, porosity, pore density and/or pore size) of the resiliently deformable (e.g. compressible) region is substantially uniform along no less than about 50%, for example, no less than about 75%, or no less than about 95%, for example along about 100%, of the longitudinal length of the roller in the undeformed (e.g. uncompressed) state. Additionally or alternatively, it may be that the structure (e.g. density, porosity, pore density and/or pore size) of the resiliently deformable (e.g. compressible) region is substantially uniform throughout no less than about 50%, for example, no less than about 75%, or no less than about 95%, of the volume of the resiliently deformable (e.g. compressible) region in the undeformed (e.g. uncompressed) state. It will be appreciated that in this regard the term “substantially uniform” encompasses minor variations in the structure (e.g. density, porosity, pore density and/or pore size) of the resiliently deformable (e.g. compressible) region, for example variations of no greater than about 15% in terms of the density, porosity, pore density and/or pore size.

It may be that the resiliently deformable (e.g. compressible) region has a Shore A hardness no greater than about 40, for example, no greater than about 30, or no greater than about 20, or no greater than about 15. It may be that the resiliently deformable (e.g. compressible) region has a Shore A hardness no less than about 1, for example, no less than about 5, or no less than about 8. It may be that the resiliently deformable (e.g. compressible) region has a Shore A hardness from about 1 to about 40, for example, from about 1 to about 30, or from about 1 to about 20, or from about 1 to about 15, or from about 5 to about 30, or from about 5 to about 20, or from about 8 to about 20, or from about 5 to about 15, or from about 8 to about 15.

It may be that the resiliently deformable (e.g. compressible) region has a tear resistance (according to ASTM D412) of less than about 10 kN/m, for example less than about 5 kN/m, or less than about 3 kN/m, or less than about 1 kN/m.

The resiliently deformable (e.g. compressible) region may have a porosity of no greater than about 150 pores per inch (ppi), for example no greater than about 125 ppi, or no greater than about 100 ppi, or no greater than about 50 ppi, or no greater than about 25 ppi, or no greater than about 10 ppi, for example about 0 ppi. The resiliently deformable (e.g. compressible) region may have a porosity of no less than about 5 ppi, for example, no less than about 10 ppi, or no less than about 20 ppi, or no less than about 30 ppi. The resiliently deformable (e.g. compressible) region may have a porosity from about 0 ppi to about 150 ppi, for example from about 0 ppi to about 125 ppi, or from about 0 ppi to about 100 ppi, or from about 0 ppi to about 50 ppi, or from about 0 ppi to about 25 ppi, or from about 0 ppi to about 10 ppi, or from about 10 ppi to about 150 ppi, or from about 20 ppi to about 125 ppi, or from about 30 ppi to about 100 ppi. The resiliently deformable (e.g. compressible) region may be a closed-cell foam and therefore have a porosity of no greater than about 10 ppi, for example of about 0 ppi. The resiliently deformable (e.g. compressible) region may be an open-cell foam and have a porosity from about 10 ppi to about 150 ppi, for example from about 20 ppi to about 125 ppi, or from about 30 ppi to about 100 ppi.

It may be that the resiliently deformable (e.g. compressible) region comprises (e.g. is formed from) a polymeric material. It may be that the resiliently deformable (e.g. compressible) region comprises (e.g. is formed from) a thermoplastic polymeric material. It may be that the resiliently deformable (e.g. compressible) region comprises (e.g. is formed from) an elastomeric material. It may be that the resiliently deformable (e.g. compressible) region comprises (e.g. is formed from) a polyurethane, for example a flexible (i.e. soft) polyurethane. It may be that the resiliently deformable (e.g. compressible) region comprises (e.g. is formed from) a rubber, for example natural rubber or synthetic rubber, e.g. natural or synthetic latex.

It may be that the resiliently deformable (e.g. compressible) region comprises (e.g. is formed from) a viscoelastic material, e.g. a viscoelastic gel.

It may be that the resiliently deformable (e.g. compressible) region comprises (e.g. is formed from) a polymeric foam (i.e. a foam of a polymeric material). It may be that the resiliently deformable (e.g. compressible) region comprises (e.g. is formed from) a thermoplastic polymeric foam (i.e. a foam of a thermoplastic polymeric material). It may be that the resiliently deformable (e.g. compressible) region comprises (e.g. is formed from) an elastomeric foam (i.e. a foam of an elastomeric material). It may be that the resiliently deformable (e.g. compressible) region comprises (e.g. is formed from) a polyurethane foam, for example a flexible (i.e. soft) polyurethane foam. It may be that the resiliently deformable (e.g. compressible) region comprises (e.g. is formed from) a rubber foam, for example natural rubber foam or synthetic rubber foam, e.g. natural or synthetic latex foam.

It may be that the resiliently deformable (e.g. compressible) region and the exterior abrasion-resistant skin are chemically distinct from one another (for example, they are formed from compositionally different materials, e.g. different polymeric materials).

It may be that the resiliently deformable (e.g. compressible) region and the exterior abrasion-resistant skin are structurally (e.g. microstructurally) distinct from one another (for example, they may be formed from compositionally the same or different materials, e.g. the same or different polymeric materials, arranged in different structures (e.g. microstructures)). For example, it may be that the resiliently deformable (e.g. compressible) region is cellular (e.g. porous) and the exterior abrasion-resistant skin is non-cellular (e.g. non-porous).

It may be that there is an interface between the interior roller body (e.g. the resiliently deformable (e.g. compressible) region) and the exterior abrasion-resistant skin. It may be that there is a discontinuous change (e.g. a step change) in physical and/or chemical properties of the roller at the interface. For example, it may be that there is a discontinuous change (e.g. step change) in structure, density, porosity, pore density and/or pore size at the interface. It may be that there is a discontinuous change (e.g. step change) in chemical composition at the interface. The discontinuous change (e.g. step change) in physical and/or chemical properties may take place over a distance of no greater than about 50 μm, for example no greater than about 25 μm, or no greater than about 10 μm (measured along the axis perpendicular to the longitudinal axis of the roller).

It may be that the interior roller body comprises a roller support shaft surrounded by the resiliently deformable (e.g. compressible) region. It may be that the roller support shaft extends along the longitudinal axis of the roller. It may be that first and second opposing ends of the roller support shaft are configured for mounting to a vacuum cleaner head.

It may be that the roller is elongate. It may be that the cross-sectional shape of the roller perpendicular to the longitudinal axis is substantially uniform along the length of the roller. For example, it may be that the cross-sectional shape of the roller perpendicular to the longitudinal axis is substantially uniform along at least about 50%, for example at least about 75%, or at least about 95%, for example along about 100%, of the longitudinal length of the roller.

It may be that the roller is substantially prismatic (i.e. a prism in shape). It may be that the roller has a substantially polygonal shape in cross-section perpendicular to the longitudinal axis. It may be that the polygonal cross-sectional shape of the roller perpendicular to the longitudinal axis has at least three sides, for example at least four sides, or at least five sides, or at least six sides, or at least seven sides, or at least eight sides, or at least nine sides, or at least ten sides. For example, it may be that the roller has a cross-sectional shape, perpendicular to the longitudinal axis, which is substantially triangular, quadrilateral, pentagonal, hexagonal, heptagonal, octagonal, nonagonal or decagonal. It may be that the substantially polygonal shape of the roller in cross-section perpendicular to the longitudinal axis is convex, equiangular, equilateral and/or cyclic.

It may be that the substantially polygonal cross-sectional shape is a substantially rounded polygonal cross-sectional shape. For example, it may be that vertices of the substantially polygonal cross-sectional shape are rounded. Additionally or alternatively, it may be that sides of the substantially polygonal cross-sectional shape of the roller are (i.e. gently) curved. For example, it may be that each side of the substantially polygonal cross-sectional shape is curved such that a maximum perpendicular distance between the external surface of the roller (at the said side) and a straight line connecting adjacent vertices of the polygonal cross-sectional shape is no greater than about 10%, for example no greater than about 5%, of the straight-line distance between said adjacent vertices.

It may be that the roller is substantially cylindrical. It may be that the roller has a substantially circular cross-sectional shape perpendicular to the longitudinal axis.

According to a second aspect, there is provided a vacuum cleaner head comprising the roller according to the first aspect. The roller may be mounted in the vacuum cleaner head. The roller may be mounted adjacent a suction inlet of the vacuum cleaner head. For example, the roller may be mounted to one side of the suction inlet of the vacuum cleaner head. The roller may be mounted forward of the suction inlet of the vacuum cleaner head.

The vacuum cleaner head may further comprise an agitator such as a beater bar. The roller and the agitator may be provided on opposing sides of the vacuum cleaner head, for example on opposing sides of the suction inlet of the vacuum cleaner head. Alternatively, the roller and the agitator may be provided on the same side of the vacuum cleaner head, for example on the same side of the suction inlet. For example, the roller and the agitator may both be provided forward of the suction inlet of the vacuum cleaner head. In some examples, however, the vacuum cleaner head does not comprise an agitator.

According to a third aspect, there is provided a vacuum cleaner comprising the roller according to the first aspect or the vacuum cleaner head according to the second aspect. The vacuum cleaner may further comprise a suction source (for example, a motor and an impeller) to generate an airflow through the cleaner head and separation system for separating dirt or dust from the airflow.

According to a fourth aspect, there is provided a kit of parts comprising a vacuum cleaner head and/or a vacuum cleaner, and the roller according to the first aspect. The roller may be mountable in, or mounted in, the vacuum cleaner head.

According to a fifth aspect, there is provided a method of manufacturing a roller for a vacuum cleaner, the method comprising: forming an interior roller body having a resiliently deformable (e.g. compressible) region; and forming an exterior abrasion-resistant skin which surrounds the interior roller body.

The method may comprise providing a preformed sheath which corresponds to (e.g. is) the exterior abrasion-resistant skin.

The resiliently deformable (e.g. compressible) region and the exterior abrasion-resistant skin may be formed, mutatis mutandis, from any materials discussed hereinabove with regard to the first aspect.

It may be that the method comprises forming the interior roller body within the preformed sheath. It may be that the method comprises forming a foam within the preformed sheath. The foam may be a polymeric foam. The foam (e.g. the polymeric foam) may form the resiliently deformable (e.g. compressible) region.

The method may comprise injecting polymeric foam into the preformed sheath.

Alternatively, the method may comprise injecting precursors for the polymeric foam into the preformed sheath. For example, the precursors for the polymeric foam may comprise one or more substances (e.g. monomers) which react to form a polymeric material and one or more foaming agents (e.g. surfactants and/or blowing agents). For example, the polymeric foam may be a polyurethane foam and the precursors may include isocyanates, polyols and water.

It may be that the method comprises forming the interior roller body and subsequently forming the exterior abrasion-resistant skin around the interior roller body.

It may be that the method comprises inserting the interior roller body into the preformed sheath, the preformed sheath corresponding to the exterior abrasion-resistant skin.

It may be that the method comprises adhering the preformed sheath to the interior roller body, the preformed sheath corresponding to the exterior abrasion-resistant skin.

It may be that the method comprises attaching the exterior abrasion-resistant skin to the interior roller body. It may be that the method comprises wrapping the exterior abrasion-resistant skin around the interior roller body. It may be that the method comprises wrapping a sheet or film around the interior roller body, the sheet or film corresponding to the exterior abrasion-resistant skin. It may be that the method comprises adhering the sheet or film to the interior roller body.

It may be that the method comprises coating the interior roller body with material to form the exterior abrasion-resistant skin. The material with which the interior roller body is coated may be the exterior abrasion-resistant skin material or one or more precursors for forming the exterior abrasion-resistant skin material. For example, the method may comprise coating the interior roller body in molten exterior abrasion-resistant skin material. Alternatively, the method may comprise coating the interior roller body in a liquid containing the exterior abrasion-resistant skin material or one or more precursors therefor, for example in solution or dispersion. Suitable coating methods include painting, dip-coating and spray-coating.

It may be that forming the interior roller body comprises forming foam within a mould. The foam may be polymeric foam. The foam (e.g. the polymeric foam) may form the resiliently deformable (e.g. compressible) region.

It may be that forming the interior roller body comprises injecting polymeric foam into the mould. Alternatively, forming the interior roller body may comprise injecting precursors for the polymeric foam into the mould. For example, the precursors for the polymeric foam may comprise one or more substances (e.g. monomers) which react to form a polymeric material and one or more foaming agents (e.g. surfactants and/or blowing agents). For example, the polymeric foam may be a polyurethane foam and the precursors may include isocyanates, polyols and water.

For example, the method may comprise: first, forming the interior roller body by forming a foam within a mould; and second, forming the exterior abrasion-resistant skin around the interior roller body, for example by inserting the interior roller body into the preformed sheath, adhering the preformed sheath around the interior roller body, wrapping the sheet or film around the interior roller body, or coating the interior roller body with material.

The method may comprising forming the resiliently deformable (e.g. compressible) region around a roller shaft, for example by inserting the roller shaft into the preformed sheath or mould and injecting foam into the preformed sheath or mould around the roller shaft. Alternatively, the method may comprise inserting the roller shaft into the resiliently deformable (e.g. compressible) region, for example during forming the resiliently deformable (e.g. compressible) region (for example, by inserting the roller shaft into uncured foam within the preformed sheath or mould) or subsequent to forming the resiliently deformable (e.g. compressible) region (for example, by inserting the roller shaft into a cured foam region, optionally wherein the method comprises first forming a cavity in the cured foam region to receive the roller shaft).

The skilled person will appreciate that, except where mutually exclusive, a feature described in relation to any one of the above aspects may be applied mutatis mutandis to any other aspect. Furthermore, except where mutually exclusive, any feature described herein may be applied to any aspect and/or combined with any other feature described herein.

### FIGURES

Embodiments will now be described by way of example only, with reference to the Figures, in which:

FIG. 1 shows a vacuum cleaner with a cleaner head;

FIG. 2 shows a front view of the cleaner head of FIG. 1;

FIG. 3 shows a cross-section of the cleaner head of FIG. 2;

FIG. 4 shows a cross-section of a roller of the cleaner head of FIGS. 1, 2 and 3; and

FIG. 5 illustrates schematically a method of manufacturing a roller for a vacuum cleaner head.

### DETAILED DESCRIPTION

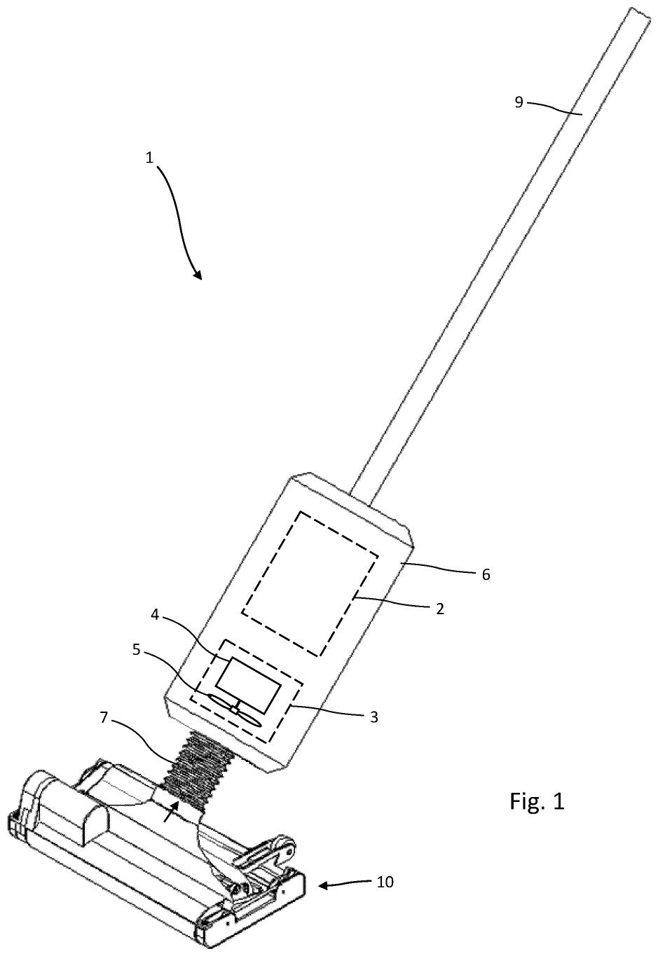

FIG. 1 shows a vacuum cleaner 1 comprising a cleaner head 10, a separation system 2, a suction source 3 and duct 7 which connects to the cleaner head 10. The separation system 2 and the suction source 3 may be housed within a housing 6. The vacuum cleaner 1 comprises a handle 9 for pushing the cleaner head across a floor surface.

Duct 7 is fluidly connected to the cleaner head 10 and to the separation system 2. Duct 7 is configured to carry dirt-laden fluid (e.g. air) from the cleaner head 10 to the separation system 2. Duct 7 may be a flexible hose, rigid pipe or any other type of fluid-carrying duct.

The separation system 2 is configured to separate dirt/dust/debris from the fluid received via duct 7. The separation system 2 can be of any kind, such as a filter bag, a cyclonic separation system (with one or more cyclonic separation stages), a water filter, an electrostatic filter. The separation system may comprise a porous filter, or may not comprise a porous filter. The suction source 3 may comprise an electrical motor 4 and an impeller 5. The suction source 3 may be located downstream of the separation system 2, or the suction source 3 may be located upstream of the separation system 2. Locating the suction source 3 downstream of the separation system 2 is advantageous, as the suction source operates upon cleaned fluid (air) rather than dirt-laden fluid. The “fluid” that is carried along duct 7 may be air. Alternatively, the fluid may be water, a cleaning fluid, or some other fluid.

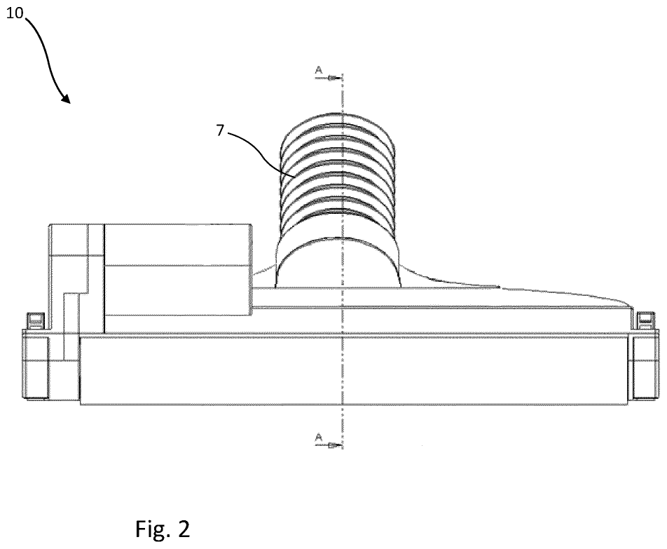

FIG. 2 shows the cleaner head 10 with duct 7. Although the duct shown is central it could be offset or positioned anywhere along the width of the cleaner head 10.

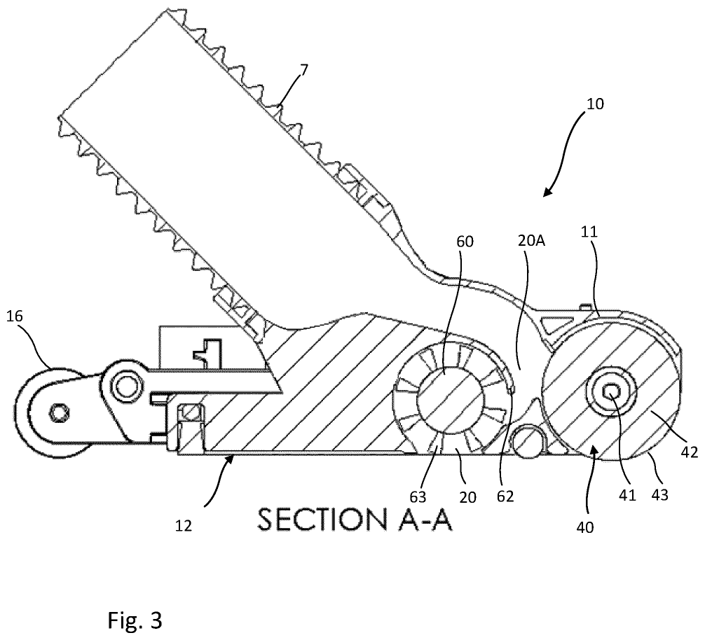

FIG. 3 shows a cross-section A-A through the cleaner head of FIG. 2. The cleaner head 10 comprises a housing 11. The housing 11 has a lower face 12. This is often called a sole plate. The lower face is the part of the cleaner head 10 which faces a floor surface. The lower face 12 comprises a frame of the housing 11 with apertures defined in it to allow air flow to/from the floor surface, and to allow components such as the roller 40 and an agitator 60 to make contact with the floor surface. The agitator in this embodiment is constructed of radially protruding stiff nylon bristles 63 which are designed to impart a parting force to the carpet pile. However, in other embodiments the agitator may take a different design or even be absent. The lower face 12 is configured to move across a surface to be cleaned. The housing may comprise one or more wheels 16, rollers or other features to assist movement of the cleaner head 10 across a floor surface.

The cleaner head 10 comprises a suction inlet 20 defined in the lower face (sole plate) 12 of the housing. There is a suction passageway 20A through the housing 11. The suction passageway 20A is in fluid communication with the suction inlet 20 and with the duct 7. The cleaner head 10 comprises the roller 40 located at a front of the housing 11. The roller 40 is configured for rotation about a rotational axis 41. For example, the roller 40 may be supported by the housing 12 at each end. The rotational axis 41 is parallel to the lower face 12 of the cleaner head. The housing 11 at least partially surrounds the roller 40. In this example, the housing 11 surrounds an upper portion of the roller 40, above the rotational axis 41. A lower portion of the roller 40 is configured to make contact with the surface to be cleaned. The front of the roller 40 is exposed, allowing the roller 40 to serve as a bumper when the cleaner head 10 pushes against an upright object, such as a skirting board or furniture.

FIG. 3 shows the cleaner head comprising an agitator, such as a beater bar (brush bar) 60. A drive, such as an electric motor, is provided to drive the agitator 60. The agitator 60 may rotate at speeds of up to 20000 RPM for effective agitation of carpets and rugs. The drive for the agitator 60 may be turned on and off, such as by a switch on the vacuum cleaner. For example, a user may choose to switch the agitator off when cleaning hard floors, where there is not a need to “beat” the carpet. A single drive may be provided for both the agitator 60 and the rotatable element 40, with transmission to distribute motor power to the agitator 60 and the roller 40. The roller is preferably rotated at speeds in the range of 30-500 RPM for example but could equally operate in the range of 500-2000 RPM.

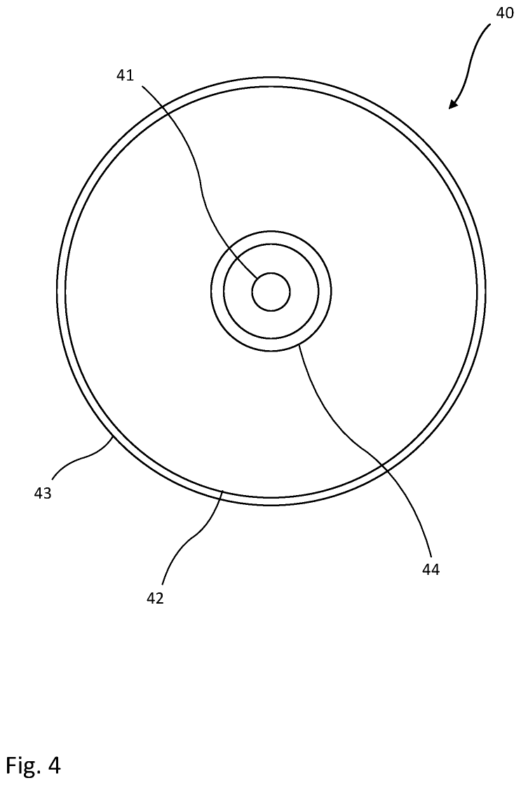

The structure of the roller 40 is shown in more detail in FIG. 4. The roller 40 includes an interior roller body, including a region of resiliently deformable (e.g. compressible) material 42 and a roller shaft 44, and an exterior abrasion-resistant skin 43.

The resiliently deformable (e.g. compressible) material of the interior roller body 42 may be a foam, such as an open-cell foam (for example, having a porosity of between about 30 and 100 ppi) or a closed-cell foam (for example, a flexible polyurethane foam or a latex foam), or any other suitable deformable (e.g. compressible) material such as an elastomeric material (e.g. a soft rubber) or a viscoelastic material (e.g. a viscoelastic gel).

Accordingly, the region of resiliently deformable (e.g. compressible) material 42 may be porous or non-porous, dependent on the material selected. In any case, the region of resiliently deformable (e.g. compressible) material is typically soft. An example of a suitable resiliently deformable (e.g. compressible) material has a Shore A hardness from about 8 to about 15 and a tear resistance of the order of 1 kN/m.

The exterior abrasion-resistant skin 43 may be formed of any suitable abrasion-resistant material, such as an abrasion-resistant polymer (such as polyether-based thermoplastic polyurethane, polyvinyl chloride or rubber) or an abrasion-resistant fabric (such as a nylon- or aramid-based fabric). The exterior abrasion-resistant skin 43 is typically non-porous. An example of a suitable abrasion-resistant material has a Shore A hardness from about 80 to about 90, a tensile strength of about 50 MPa, a tear resistance greater than about 60 kN/m and an abrasion loss (during abrasion resistance testing according to DIN 53516) less than about 70 mm³, and preferably less than about 30 mm³. The exterior abrasion-resistant skin is between about 100 μm and 1000 μm (e.g. between about 200 μm and 300 μm) thick.

In use, the roller 40 functions as a rotatable sealing element, i.e. the rotatable sealing element 40 can form a seal, or a partial seal, between the cleaner head 10 and a surface to be cleaned. The seal or partial seal is formed by pressing the abrasion-resistant exterior skin 43 of the roller against the surface to be cleaned. The use of a non-porous material to form the exterior skin 43 results in an improved seal and enables use of porous materials, if desired, in manufacturing the resiliently deformable (e.g. compressible) region 42 without loss of suction. In turn, the resiliently deformable (e.g. compressible) material 42 enables the roller 40 to deform (e.g. compress) when rolling over debris to accommodate the debris and then to return to its initial shape after the debris has been removed, such that the exterior abrasion-resistant skin 43 can be maintained in sealing contact with the surface to be cleaned as the roller 40 rolls over the debris. Maintenance of a seal or partial seal limits air being drawn into the vacuum cleaner from the front of the head and encourage air to be drawn from underneath the head. The roller 40 can therefore allow debris to enter the cleaner head 10, rather than pushing the debris in front of the cleaner head, while also maintaining the seal.

The inventors have found that the particular two-part structure of the roller 40, which includes the abrasion-resistant exterior skin 43 surrounding an interior roller body comprising the resiliently deformable (e.g. compressible) region 42, is particularly advantageous in comparison to a roller having a unitary structure (i.e. having an interior body and exterior surface made of the same material with the same or similar microstructure). In particular, the two-part structure enables the deformability (e.g. compressibility) of the resiliently deformable (e.g. compressible) region and the abrasion-resistance and sealing properties of the exterior skin to be independently optimised. In contrast, a unitary structure made of sufficiently deformable material is typically found to have poor abrasion resistance, while a unitary structure made of abrasion-resistant material is typically found to be excessively hard or heavy such that deformation of the roller when rolling over debris is not possible (leading either to crushing the debris or to loss of the seal between the roller and the surface). The benefits of the two-part structure are more pronounced when there is a distinct interface (i.e. where there is a discontinuous change in composition and/or microstructure) between the resiliently deformable (e.g. compressible) region and the abrasion-resistant skin.

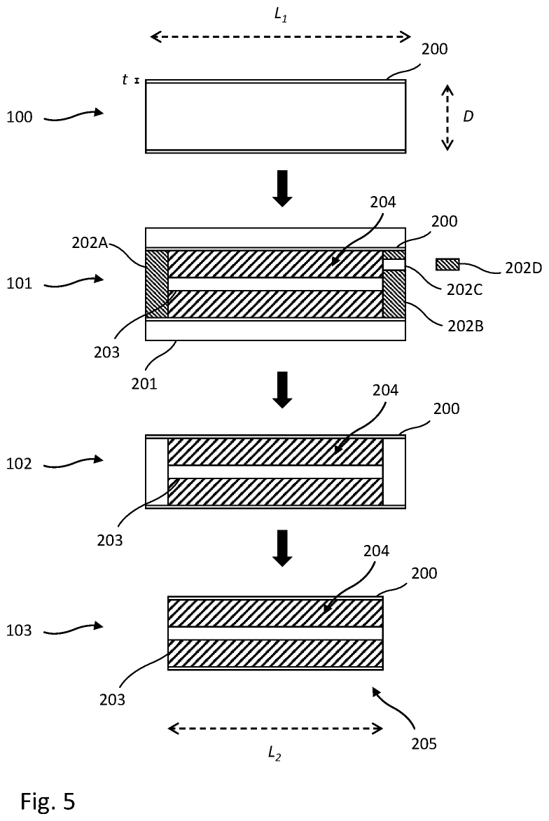

FIG. 5 illustrates an example method for manufacturing a roller 205 of the same type as roller 40. In step 100, polyether-based thermoplastic polyurethane is extruded to form a cylindrical sheath or sleeve 200 having a thickness, t, of about 100 μm to about 1000 μm (e.g. about 200 μm to 300 μm), a length, L₁, of about 260 mm and a diameter, D, of about 45 mm. The sheath may have a matt or textured surface finish.

In step 101, the sheath 200 is inserted into a cylindrical mould 201. A roller shaft 203 is inserted into, and aligned with a longitudinal axis of, the sheath 200 within the mould 201. Circular mould end stops 202A and 202B are used to hold the sheath flush against the internal walls of the mould 201. A flexible polyurethane foam 204 is injected into the sheath 200 through pouring hole 202C in end stop 202B, the foam filling the space bounded by the sheath 200, the end stops 202A and 202B, and the roller shaft 203.

Once filled, the pouring hole 202C is closed by cap 202D. The foam 204 is allowed to cure within the sheath 200 until solid. Vent holes (not shown) in the mould 201 accommodate expansion of the foam.

In step 102, once the foam 204 has set, the sheath 200 is removed from the mould 201 and the end stops 202A and 202B are removed from within the sheath.

In step 103, the ends of the sheath 200 are trimmed to achieve a roller 205 having a final roller length, L₂, of about 240 mm. The foam 204 corresponds to the resiliently deformable (e.g. compressible) region of the roller, while the sheath 200 corresponds to the exterior abrasion-resistant skin.

It will be appreciated that the materials used to manufacture the resiliently deformable (e.g. compressible) region and the exterior abrasion-resistant skin can be varied, as discussed hereinabove, in order to target particular mechanical properties. The cross-sectional shape of the roller may also be varied. The skilled person will also appreciate that a number of a different methods may be used to manufacture to manufacture the roller. For example, in an alternative method of manufacture, the interior body of the roller is formed separately within a mould and the exterior skin is applied to the interior body once formed. For example, a foam could be cured in a mould around a roller shaft to form the interior body, and then a sheet of abrasion resistant material could be adhered to the exterior of the interior body to form the exterior skin. Alternatively, the interior body could be coated in material (for example, by painting, dip-coating or spray-coating) to form the exterior skin.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A roller for a vacuum cleaner, the roller comprising: an interior roller body which comprises a resiliently deformable region; and an exterior abrasion-resistant skin which surrounds the interior roller body, wherein the exterior abrasion-resistant skin is formed from a non-porous material and exhibits an abrasion loss, during abrasion resistance testing according to DIN 53516, of no greater than 150 mm³.

2. The roller according to claim 1, wherein the resiliently deformable region is a resiliently compressible region.

3. (canceled)

4. The roller according to claim 1, wherein the exterior abrasion-resistant skin exhibits an abrasion loss, during abrasion resistance testing according to DIN 53516, from 15 mm³ to 150 mm³.

5. The roller according to claim 1, wherein the exterior abrasion-resistant skin is formed from an abrasion-resistant polymeric material.

6. The roller according to claim 5, wherein the exterior abrasion-resistant skin is formed from thermoplastic polyurethane.

7. The roller according to claim 1, wherein the exterior abrasion-resistant skin has:
(a) a Shore A hardness greater than 40;
(b) a tensile strength of greater than 10 MPa;
(c) an elongation to failure greater than 200%; and/or
(d) a tear resistance greater than 20 kN/m.

8. The roller according to claim 1, wherein the exterior abrasion-resistant skin is adhered to the interior roller body.

9. The roller according to claim 1, wherein the exterior abrasion-resistant skin has a thickness from 100 μm to 400 μm.

10. (canceled)

11. The roller according to claim 1, wherein the resiliently deformable region and the exterior abrasion-resistant skin are chemically distinct from one another.

12. The roller according to claim 1, wherein the resiliently deformable region has a Shore A hardness no greater than 20 and/or a tear resistance of less than 10 kN/m.

13. The roller according to claim 1, wherein the resiliently deformable region is porous.

14. The roller according to claim 13, wherein the porosity, pore size and/or pore density of the resiliently deformable region is substantially uniform in an undeformed state.

15. (canceled)

16. (canceled)

17. The roller according to claim 1, wherein the interior roller body comprises a roller support shaft surrounded by the resiliently deformable region.

18. (canceled)

19. (canceled)

20. A vacuum cleaner head comprising a roller, the roller comprising: an interior roller body which comprises a resiliently deformable region; and an exterior abrasion-resistant skin which surrounds the interior roller body, wherein the exterior abrasion-resistant skin is formed from a non-porous material and exhibits an abrasion loss, during abrasion resistance testing according to DIN 53516, of no greater than 150 mm³.

21. (canceled)

22. (canceled)

23. A method of manufacturing a roller for a vacuum cleaner, the method comprising: forming an interior roller body having a resiliently deformable region; and forming an exterior abrasion-resistant skin which surrounds the interior roller body, wherein the exterior abrasion-resistant skin is formed from a non-porous material and exhibits an abrasion loss, during abrasion resistance testing according to DIN 53516, of no greater than 150 mm³.

24. (canceled)

25. The method according to claim 23 comprising forming the interior roller body within a preformed sheath, the preformed sheath corresponding to the exterior abrasion-resistant skin.

26. The method according to claim 23 comprising forming the interior roller body and subsequently forming the exterior abrasion-resistant skin around the interior roller body.

27. The method according to claim 26 comprising inserting the interior roller body into a preformed sheath, the preformed sheath corresponding to the exterior abrasion-resistant skin.

28. The method according to claim 23 comprising adhering a preformed sheath to the interior roller body, the preformed sheath corresponding to the exterior abrasion-resistant skin.

29. The roller according to claim 1, wherein the exterior abrasion-resistant skin and the interior roller body are held in contact by an interference fit between the exterior abrasion-resistant skin and the interior roller body.
